(19) United States
(12) Patent Application Publication
(10) Pub. No.: US 2025/0264674 A1
(43) Pub. Date: Aug. 21, 2025

(54) OPTICAL CONNECTOR AND RECEPTACLE WITH INTERLOCK FEATURES

(71) Applicant: Molex, LLC, Lisle, IL (US)

(72) Inventors: Andrew Karl Eckhart, Lombard, IL (US); Wenzong Chen, Naperville, IL (US); Joshua Krantz, Wheaton, IL (US)

(21) Appl. No.: 19/052,331

(22) Filed: Feb. 13, 2025

Related U.S. Application Data
(60) Provisional application No. 63/556,025, filed on Feb. 21, 2024.

(51) Int. Cl. G02B 6/38

(52) U.S. Cl. CPC G02B 6/3893; G02B 6/3821; G02B 6/3831; G02B 6/3885

(57) ABSTRACT

Examples of optical connectors with interlock features are described. An example optical connector assembly includes a receptacle and a cartridge. The receptacle includes a receptacle housing having a receptacle cavity and a cantilevered latch tab within the receptacle cavity. The cartridge includes a cartridge housing with an interlock ledge along a side of the cartridge housing. The cartridge also includes a release sleeve with a ramped interlock aperture. The release sleeve is positioned over the cartridge housing of the cartridge. The interlock ledge on the cartridge housing is exposed in part though the ramped interlock aperture of the release sleeve. When the cartridge is inserted into the receptacle, the cantilevered latch tab of the receptacle mechanically joins and interferes with the interlock ledge of the cartridge, holding the cartridge in place within the receptacle.

### BACKGROUND

The amount of data processed by computing, network switching, telecommunications, and related systems continues to increase. Data centers can include hundreds or thousands of networking and computing systems. The systems are interconnected by optical cables, copper cables, and various connectors, adapters, and terminations between them. The data throughput of the interconnection systems is high and increasing. A range of different input/output (I/O) connectors, cables, cable assemblies, and interconnect systems are designed for those types of data, power, and data and power interconnection applications.

Example interconnect systems include board-to-board, cable-to-cable, wire-to-wire, and cable-or wire-to-board systems. A variety of designs exist for each type of connector, cable assembly, and interconnect system, depending on the requirements of the power and data communications environment in which the connectors, assemblies, and systems are used. As one example, a cable-to-cable optical connector assembly includes an optical cartridge attached to the free end of a fiber optical cable assembly and an optical receptacle connector attached to a bulkhead. The optical cartridge can be inserted into the optical receptacle to establish optical communications through the optical connector assembly.

### SUMMARY

Optical connector assemblies including latching or interlocking features are described herein. An example optical connector assembly with latching or interlocking features includes an optical receptacle and an optical cartridge. The optical receptacle includes a first row of optical ferrules, and the optical cartridge includes a second row of optical ferrules. The first row of optical ferrules is aligned with the second row of optical ferrules when the cartridge is inserted into the receptacle, for optical communications between them.

The receptacle includes a receptacle housing having a receptacle cavity and a cantilevered latch tab within the receptacle cavity. The cartridge includes a cartridge housing with an interlock ledge along a side of the cartridge housing. The cartridge also includes a release sleeve with a ramped interlock aperture. The release sleeve is positioned over the cartridge housing of the cartridge. The interlock ledge on the cartridge housing is exposed in part though the ramped interlock aperture of the release sleeve. When the cartridge is inserted into the receptacle, the cantilevered latch tab of the receptacle mechanically joins and interferes with the interlock ledge of the cartridge, holding the cartridge in place within the receptacle.

In other aspects of the embodiments, the ramped interlock aperture includes a chamfered corner bar, an aperture through a side wall of the release sleeve, a depressed platform edge region along an edge of the aperture, and a ramped edge region along the edge of the aperture. The interlock ledge of the cartridge housing is exposed through the aperture of the ramped interlock aperture. When the optical cartridge is inserted into the receptacle cavity of the optical receptacle, the latch tooth of the cantilevered latch tab mechanically interferes with the interlock ledge of the cartridge housing, to lock the optical cartridge within the optical receptacle. Further, when the optical cartridge is locked within the optical receptacle, the release knob of the cantilevered latch tab is seated on the depressed platform edge region of the ramped interlock aperture.

In other aspects of the embodiments, the release sleeve also includes a pull tab extending from a top wall of the release sleeve and an orientation key formed on a bottom wall of the release sleeve. The release sleeve also includes flange tabs extending from side walls of the release sleeve. In other aspects, the optical receptacle includes a ferrule sled and a spring to provide a spring bias to the ferrule sled. In still other aspects, from a front to a rear of the release sleeve, the inner side surfaces of the release sleeve are drafted to expand apart from each other. Also, from a front to a rear of the cartridge housing, the spacing ribs of the cartridge housing are progressively longer.

In other embodiments, an example optical cartridge includes a cartridge housing and a release sleeve extending around a length of the cartridge housing. The cartridge housing includes spacing ribs and an interlock ledge along a side of the cartridge housing. The release sleeve includes a ramped interlock aperture. The ramped interlock aperture includes a chamfered corner bar, an aperture through a side wall of the release sleeve, a depressed platform edge region along an edge of the aperture, and a ramped edge region along the edge of the aperture. The interlock ledge of the cartridge housing is exposed through the aperture of the ramped interlock aperture. The release sleeve also includes a pull tab extending from a top wall of the release sleeve and an orientation key formed on a bottom wall of the release sleeve. The release sleeve also includes flange tabs extending from side walls of the release sleeve in one example.

In other embodiments, an optical receptacle includes a receptacle housing, a ferrule sled, and a spring to provide a spring bias to the ferrule sled. The receptacle housing includes a receptacle cavity and a cantilevered latch tab within the receptacle cavity. The cantilevered latch tab includes an extension arm, a latch tooth at an end of the extension arm, and a release knob. The receptacle housing also includes an orientation keyway formed as a slot in a bottom wall of the receptacle housing. The receptacle housing also includes guide surfaces on rails within the receptacle cavity in one example.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A illustrates a perspective view of an optical connector assembly according to various embodiments of the present disclosure.

FIG. 1B illustrates another perspective view of the optical connector assembly shown in FIG. 1A according to various embodiments of the present disclosure.

FIG. 2A illustrates a perspective view of the cartridge shown in FIG. 1A with the release sleeve omitted from view according to various embodiments of the present disclosure.

FIG. 2B illustrates a perspective view of the cartridge shown in FIG. 1A with the release sleeve and cartridge cover omitted from view according to various embodiments of the present disclosure.

FIG. 2C illustrates a top-down view of the cartridge shown in FIG. 1A with the release sleeve and cartridge cover omitted from view according to various embodiments of the present disclosure.

FIG. 3A illustrates a front perspective view of the release sleeve of the cartridge shown in FIG. 1A according to various embodiments of the present disclosure.

FIG. 3B illustrates a top-down view of the release sleeve shown in FIG. 3A according to various embodiments of the present disclosure.

FIG. 3C illustrates a side view of the release sleeve shown in FIG. 3A according to various embodiments of the present disclosure.

FIG. 3D illustrates a back perspective view of the release sleeve shown in FIG. 3A according to various embodiments of the present disclosure.

FIG. 3E illustrates a front view of the release sleeve shown in FIG. 3A according to various embodiments of the present disclosure.

FIG. 4A illustrates a top-down view of the receptacle shown in FIG. 1A according to various embodiments of the present disclosure.

FIG. 4B illustrates a bottom-up view of the receptacle shown in FIG. 4A according to various embodiments of the present disclosure.

FIG. 4C illustrates a bottom-up view of the receptacle shown in FIG. 4A with the receptacle cover omitted from view according to various embodiments of the present disclosure.

FIG. 4D illustrates the detail view designated “BB” in FIG. 4A according to various embodiments of the present disclosure.

FIG. 4E illustrates a front view of the receptacle housing shown of the receptacle shown in FIG. 4A according to various embodiments of the present disclosure.

FIG. 5 illustrates components of the receptacle shown in FIG. 1A according to various embodiments of the present disclosure.

FIG. 6A illustrates the ramped interlock aperture of the cartridge taken along the sectional plane A-A shown in FIG. 1A according to various embodiments of the present disclosure.

FIG. 6B illustrates the cantilevered latch tab and the ramped interlock aperture of the cartridge taken along the sectional plane A-A shown in FIG. 1A according to various embodiments of the present disclosure.

FIG. 6C illustrates the cantilevered latch tab and the ramped interlock aperture of the cartridge taken along the sectional plane C-C shown in FIG. 6B according to various embodiments of the present disclosure.

### DETAILED DESCRIPTION

As noted above, the amount of data processed by computers, computing systems, and computing environments continues to increase. Data centers can include hundreds or thousands of networking and computing systems that are interconnected using optical cables, copper cables, and various connectors and terminations therebetween. An example interconnect system includes a cable-to-cable optical connector assembly. The optical connector assembly includes an optical cartridge at one end of a fiber optical cable assembly and an optical receptacle connector attached to a bulkhead. The optical cartridge can be inserted into the optical receptacle to establish optical communications through the optical connector assembly.

Optical connector assemblies including latching or interlocking features are described herein. An example optical connector assembly with latching or interlocking features includes an optical receptacle and an optical cartridge. The receptacle includes a receptacle housing having a receptacle cavity and a cantilevered latch tab within the receptacle cavity. The cartridge includes a cartridge housing with an interlock ledge along a side of the cartridge housing. The cartridge also includes a release sleeve with a ramped interlock aperture. The release sleeve is positioned over the cartridge housing of the cartridge. The interlock ledge on the cartridge housing is exposed in part though the ramped interlock aperture of the release sleeve. When the cartridge is inserted into the receptacle, the cantilevered latch tab of the receptacle mechanically joins and interferes with the interlock ledge of the cartridge, holding the cartridge in place within the receptacle.

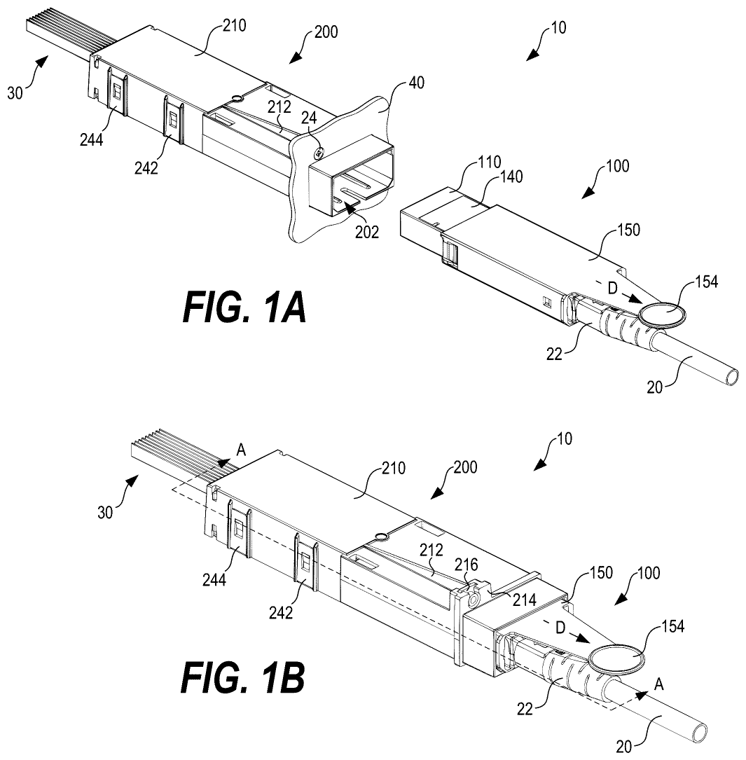

Turning to the drawings, FIG. 1A illustrates a perspective view of an optical connector assembly 10 (also “connector assembly 10”) according to various embodiments of the present disclosure. FIG. 1B illustrates another perspective view of the connector assembly 10 shown in FIG. 1A. The connector assembly 10 is provided as an example of an optical connector assembly that incorporates latching or interlocking features. The connector assembly 10 is illustrated as a representative example and is not drawn to any particular scale or size. The orientation, shape, size, style, proportion, and other characteristics of the connector assembly 10 can vary as compared to that shown and among the embodiments. In some cases, one or more features or components of the connector assembly 10 described herein can be omitted. In other cases, the connector assembly 10 can include other features or components that are not shown or described. Additionally, while the connector assembly 10 is described as an optical connector assembly, the concepts are not limited to use with optical interconnect applications or systems. The concepts can be extended to a range of different interconnect systems and applications.

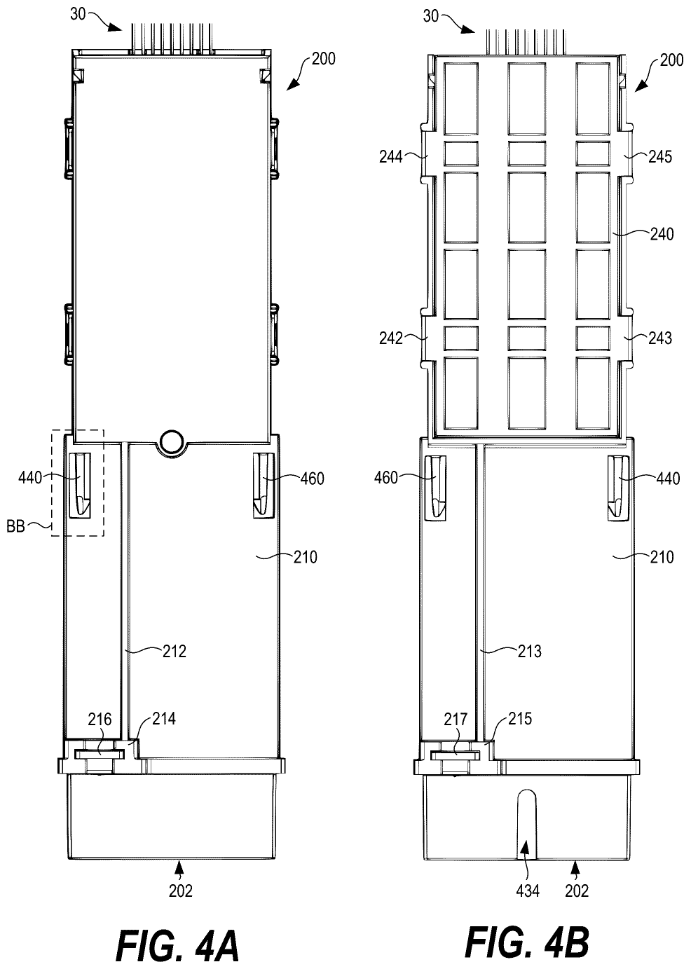

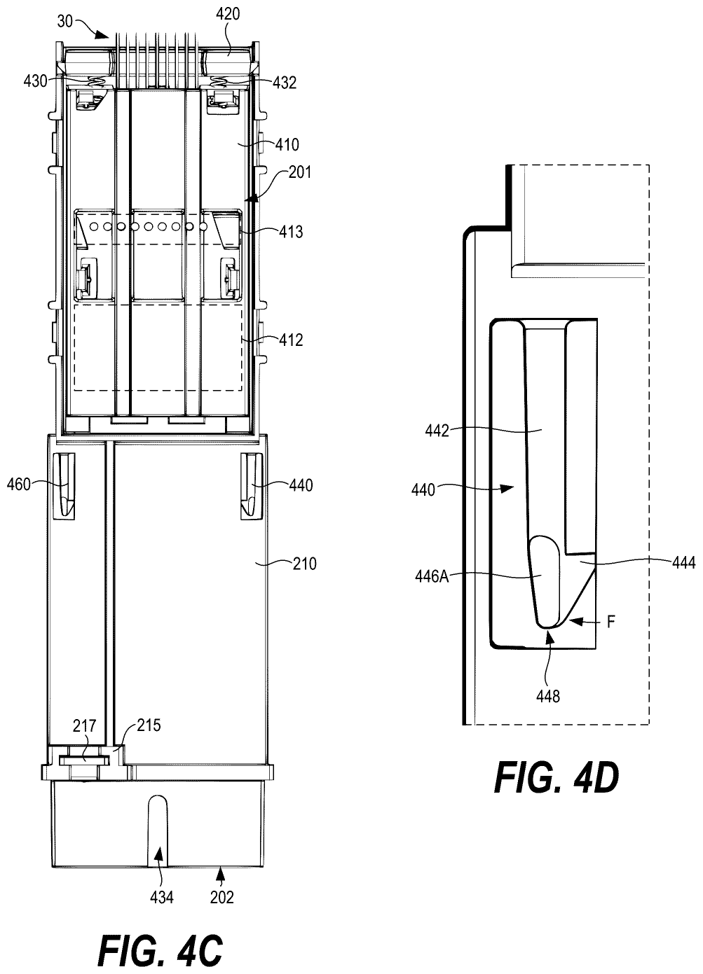

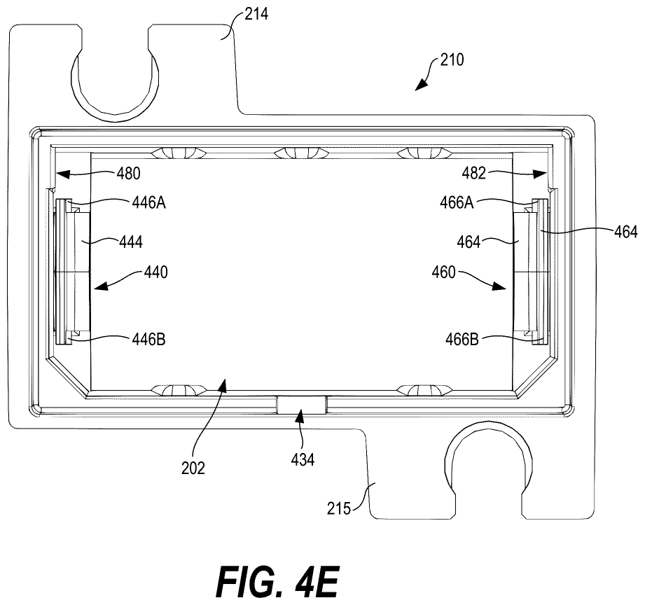

Referring between FIGS. 1A and 1B, the connector assembly 10 includes an optical cartridge 100 (also “cartridge 100”) and an optical receptacle 200 (also “receptacle 200”). FIG. 1A illustrates the cartridge 100 separated from the receptacle 200, and FIG. 1B illustrates the cartridge 100 inserted into the receptacle 200. The cartridge 100 includes a cartridge housing 110, a cartridge cover 140, and a release sleeve 150, among other components described in further detail below. The receptacle 200 includes a receptacle housing 210 and a receptacle cover 240 (see FIG. 4B), among other components described below. The receptacle housing 210 includes a receptacle cavity 202 as shown in FIG. 1A, and the cartridge 100 fits into the receptacle cavity 202 as shown in FIG. 1B.

An optical cable assembly 20 is terminated at (e.g., ends at) the cartridge 100. A first array of optical ferrules is positioned and secured within the cartridge 100. Individual fiber optic cables that extend within the cable assembly 20 are optically terminated to the optical ferrules within the cartridge 100. Similarly, fiber optic cable ribbons 30 are terminated at the receptacle 200. A second array of optical ferrules is positioned and secured within the receptacle 200. Individual fiber optic cables in the cable ribbons 30 are optically terminated to the optical ferrules within the receptacle 200. When the cartridge 100 is inserted into the receptacle 200, the first array of optical ferrules is aligned with the second array of optical ferrules, to permit the transmission of light between the first and second arrays of optical ferrules for optical communications between the cartridge 100 and the receptacle 200. Thus, the connector assembly 10 facilitates optical communications between the fiber optic cables in the cable assembly 20 and in the cable ribbons 30, as well as the connection and disconnection of the communications. These and other aspects of the embodiments are described in further detail below.

The receptacle 200 can be installed within the housing of a computing system or environment. For example, part of a housing wall 40 is shown in FIG. 1A. An end of the receptacle 200 extends through an opening in the wall 40, as shown in FIG. 1A, and the receptacle 200 is secured in place with respect to the wall 40. The receptacle 200 includes a bulkhead 214 (see FIG. 1B) with a fastener eyelet 216. The bulkhead 214 is positioned against a back surface of the wall 40 as the receptacle 200 is extended through the opening in the wall 40, and a fastener 24 (see FIG. 1A), such as a screw, is secured through the wall 40 and into the fastener eyelet 216. A stiffening rail 212 is formed as part of the receptacle housing 210, and it provides additional rigidity and support to the bulkhead 214. The connector assembly 10 can also be implemented and embodied for “inline” applications, in which neither the receptacle 200 nor the cartridge 100 is attached to a housing or wall. In that case, the stiffening rail 212, bulkhead 214, fastener eyelet 216, and possibly other features of the receptacle 200 can be omitted.

The connector assembly 10 includes latching or interlocking features. More particularly, the cartridge 100 and the receptacle 200 are interlocked with each other when the cartridge 100 is inserted into the receptacle 200 as shown in FIG. 1B. Once interlocked, the cartridge 100 cannot be pulled out from within the receptacle 200 by pulling on the cable assembly 20, for example, under expected ranges of forces and without damage. Thus, the connector assembly 10 includes features that prevent the unintended or inadvertent removal of the cartridge 100 from the receptacle 200, which would result in the disruption of data communications through the connector assembly 10.

The cartridge 100 can be pulled out and removed from within the receptacle 200, but only by first disengaging the latching or interlocking features between them. For that purpose, the release sleeve 150 includes a pull tab 154. A force applied to the pull tab 154, or another part of the release sleeve 150, in the direction “D” shown in FIGS. 1A and 1B will release or disengage the interlock between the cartridge 100 and the receptacle 200. Thus, the cartridge 100 can be pulled out from within the receptacle 200 by pulling on the pull tab 154 of the release sleeve 150. The latching and interlocking features of the connector assembly 10 are described in further detail below.

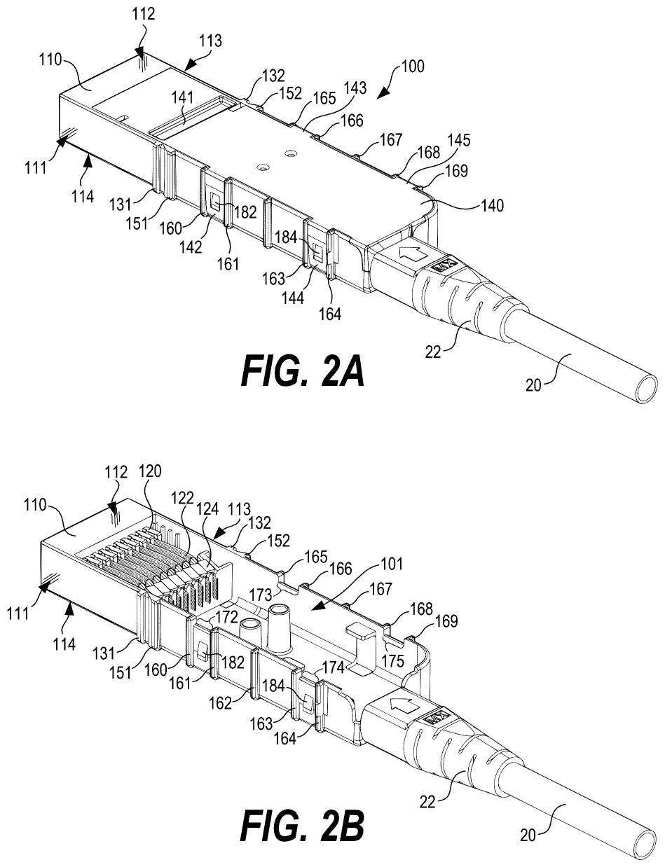

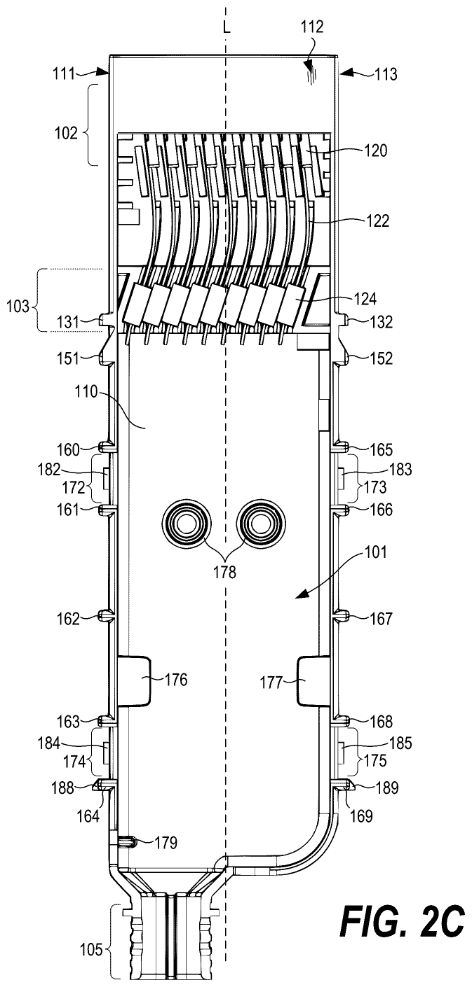

Turning to features of the cartridge 100, FIG. 2A illustrates a perspective view of the cartridge 100 shown in FIG. 1A with the release sleeve 150 omitted from view. FIG. 2B illustrates a perspective view of the cartridge 100 with the release sleeve 150 and the cartridge cover 140 omitted from view, and FIG. 2C illustrates a top-down view of the cartridge 100 with the release sleeve 150 and cartridge cover 140 omitted from view. The cartridge 100 is illustrated as a representative example in FIGS. 2A-2C and is not drawn to any particular scale or size. The orientation, shape, size, style, proportion, and other characteristics of the cartridge 100 can vary as compared to that shown and among the embodiments. In some cases, one or more features or components of the cartridge 100 can be omitted. In other cases, the cartridge 100 can include other features or components that are not shown or described.

With the release sleeve 150 omitted from view, both the cartridge housing 110 and the cartridge cover 140 are visible in FIG. 2A. The cartridge housing 110 can be formed from a plastic or polymer, such as liquid crystal polymer (LCP), polyethylene (PE), polytetrafluoroethylene (PTFE), fluoropolymer, or other plastic or insulating material(s). The cartridge cover 140 can also be formed from a plastic or polymer, such as LCP, PE, PTFE, fluoropolymer, or other plastic or insulating material(s). The cartridge housing 110 and the cartridge cover 140 are not limited to being formed from polymers, however, and the cartridge housing 110 and the cartridge cover 140 can also be formed from other suitable materials. The cartridge housing 110 and the cartridge cover 140 can be formed using any suitable additive or subtractive manufacturing techniques, including molding, injection molding, printing, and other techniques.

The cartridge housing 110 includes side walls, a top wall, and a bottom wall. More particularly, as shown in FIGS. 2A-2C, the cartridge housing 110 includes a first side surface 111 of a first side wall, a top side surface 112 of a top side wall, a second side surface 113 of a second side wall, and a bottom side surface 114 of a bottom wall. The first side surface 111 extends in a plane that is separated from and substantially parallel to the second side surface 113 in the example shown. The top side surface 112 extends in a plane that is separated from and substantially parallel to the bottom side surface 114 in the example shown. Referring to FIG. 2C, a front of the cartridge housing 110 is positioned at the top of the page and a rear of the cartridge housing 110 is positioned at the bottom of the page. The cartridge housing 110 includes a neck 105 at the rear of the cartridge housing 110, where the cable assembly 20 (see FIGS. 1A and 1B) is fed into the cartridge housing 110.

The cartridge cover 140 is formed as a planar cover. When installed over the cartridge housing 110, a top or outer surface of the cartridge cover 140 is relatively coplanar and coextensive with the top side surface 112 of the cartridge housing 110. The cartridge cover 140 is omitted from view in FIGS. 2B and 2C so that the interior space 101 within the cartridge housing 110 can be seen. When installed over the cartridge housing 110, the cartridge cover 140 encloses the interior space 101 within the cartridge housing 110.

The cartridge cover 140 includes a depressed region 141. An interior surface of the depressed region 141 contacts a row of fiber optic collets within the cartridge housing 110, as described below, and holds the collets in place. The cartridge cover 140 also includes latching tabs, such as the latching tabs 142 and 144 shown in FIG. 2A. The latching tabs 142 and 144 extend down from a first peripheral side edge of the cartridge cover 140 and interlock with features of the cartridge housing 110. The cartridge cover 140 also includes latching tabs 143 and 145 that extend down from a second peripheral side edge of the cartridge cover 140.

The interior space 101 within the cartridge housing 110 is visible in FIGS. 2B and 2C. A row of optical ferrules is positioned and secured in the interior space 101 within the cartridge housing 110. More particularly, a row of optical ferrules is secured in the ferrule region 102 within the cartridge 100 as shown in FIG. 2C. Part of an example optical ferrule 120 is identified in FIGS. 2B and 2C at one end of the row of optical ferrules in the ferrule region 102. A row of collets is also secured in a collet region 103 within the cartridge housing 110 as shown in FIG. 2C. An example collet 124 is identified at one end of the collet region 103. Fiber optic cables extend from the cable assembly 20, into the interior space 101 of the cartridge housing 110, through the collets in the collet region 103, and are optically terminated to the optical ferrules the ferrule region 102.

For simplicity, fiber optic cables are illustrated only between the collet region 103 and the ferrule region 102 of the cartridge housing 110 in FIGS. 2B and 2C. It should be appreciated, however, that fiber optic cables can extend from the cable assembly 20 and into the interior space 101 of the cartridge housing 110, although fiber optic cables are not illustrated within the interior space 101 in FIGS. 2B and 2C. In some cases, a length of the fiber optic cables can be spooled or wound up within the interior space 101, before the cables are terminated to the optical ferrules in the ferrule region 102. The cartridge housing 110 includes features to help secure, protect, and organize the fiber optic cables within the interior space 101. For example, the cartridge housing 110 includes inner tabs 176 and 177, spooling pillars 178, and a bumper 179 within the interior space 101. Depending on the lengths of the fiber optic cables, the cables can be wound around the spooling pillars 178 and tucked or otherwise positioned under the inner tabs 176 and 177. Both the inner tabs 176 and 177 and the bumper 179 can be helpful to position the fiber optic cables away from the edges of the cartridge housing 110, so that the cables are not caught or pinched when the cartridge cover 140 is secured over the cartridge housing 110. A boot 22 of the cable assembly 20 (see FIGS. 1A and 1B) can be secured over the neck 105 of the cartridge housing 110.

The cartridge housing 110 includes features that are formed along the first side surface 111 and the second side surface 113. In the example shown, the cartridge housing 110 includes a first interlock ledge 131 along the first side surface 111 and a second interlock ledge 132 along the second side surface 113. The interlock ledges 131 and 132 are positioned along the sides of the collet region 103 and to the sides of the row of collets within the cartridge housing 110. The interlock ledge 131 is formed as a raised rib or ledge that extends away from the first side surface 111 in a direction perpendicular to a longitudinal axis “L” of the cartridge housing 110. The interlock ledge 132 is also formed as a raised rib or ledge that extends away from the second side surface 113 in a direction perpendicular to a longitudinal axis “L” of the cartridge housing 110.

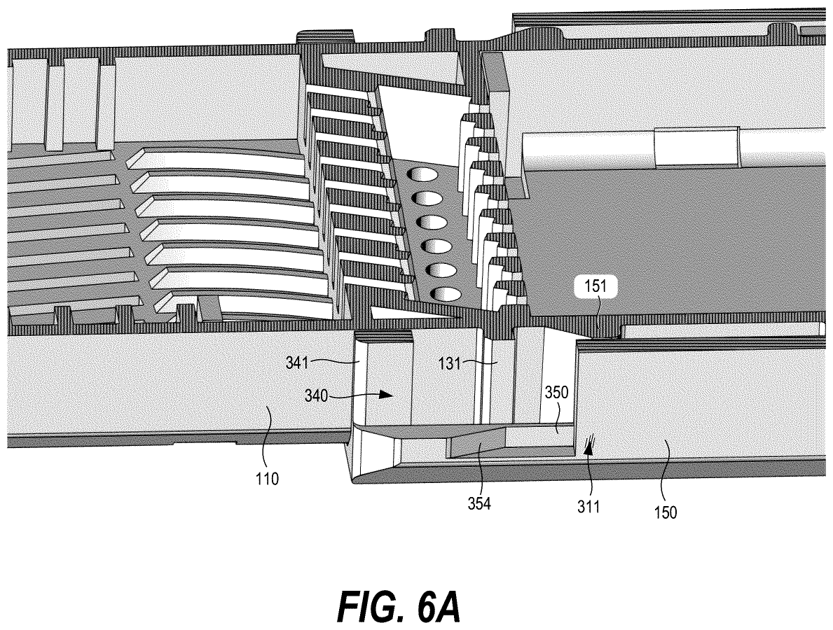

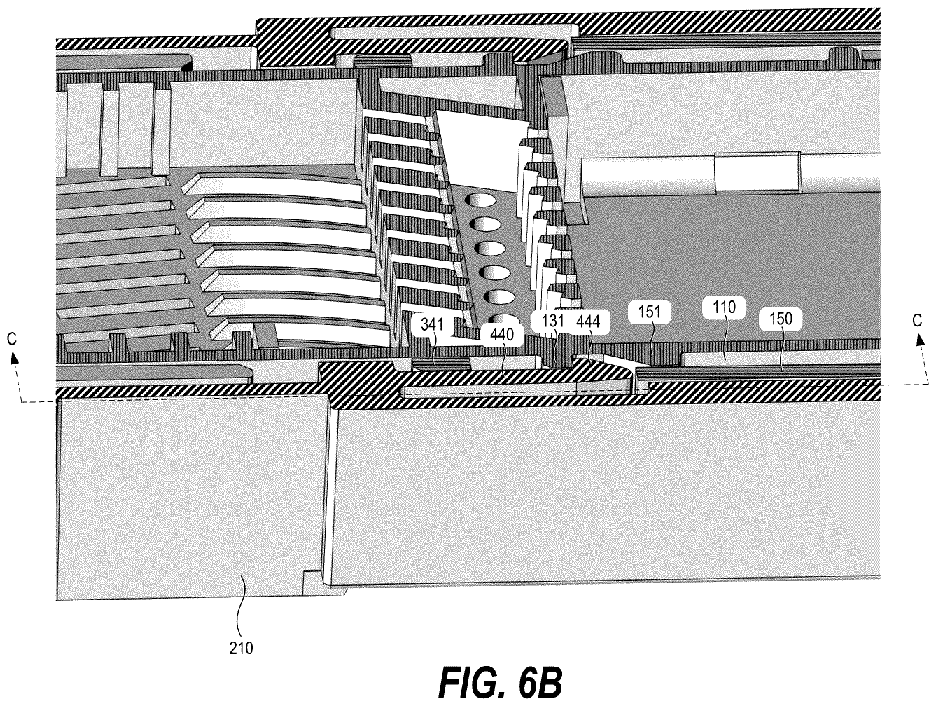

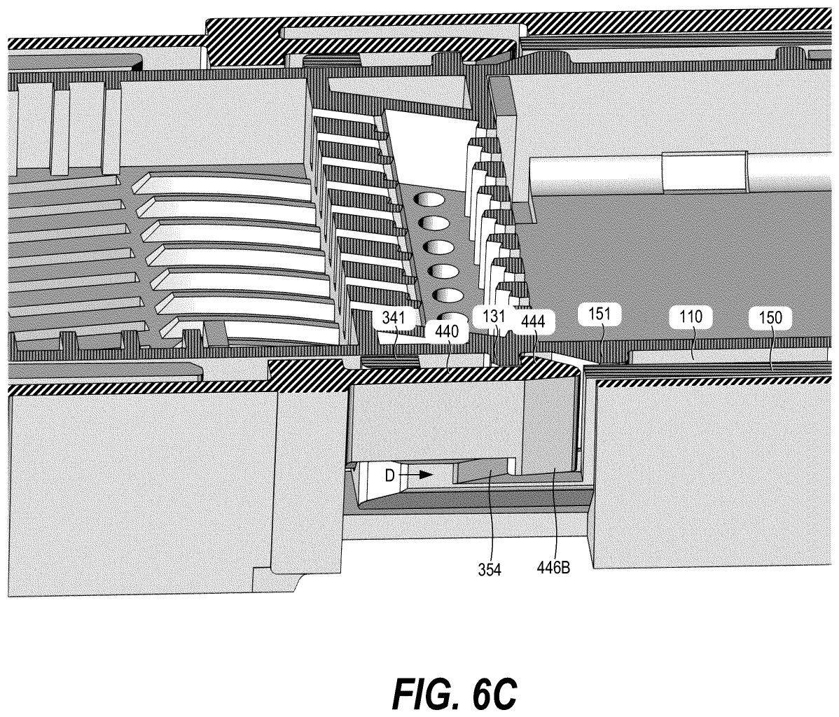

The interlock ledges 131 and 132 are structures for mechanical interference with cantilevered latch tabs that extend within the receptacle cavity 202 (see FIG. 1A) of the receptacle 200. More particularly, the cantilevered latch tabs within the receptacle cavity 202 interlock with (i.e., mechanically interfere with) surfaces of the interlock ledges 131 and 132 when the cartridge 100 is fully inserted into the receptacle 200. A force applied to the pull tab 154 in the direction “D” shown in FIGS. 1A and 1B will release or disengage the interlock between the cartridge 100 and the receptacle 200. The interlock arrangement between the cartridge 100 and the receptacle 200 is described in further detail below with reference to FIGS. 6A-6C.

The cartridge housing 110 also includes a first latch bumper 151 along the first side surface 111 and a second latch bumper 151 along the second side surface 113. The latch bumper 151 is formed as a raised and angled bumper that extends away from the first side surface 111 in a direction perpendicular to a longitudinal axis “L” of the cartridge housing 110. The latch bumper 152 is also formed as a raised and angled bumper that extends away from the second side surface 113 in a direction perpendicular to a longitudinal axis “L” of the cartridge housing 110. The latch bumpers 151 and 152 provide angled bumpers for the cantilevered latch tabs within the receptacle cavity 202 (see FIG. 1A). The angled surfaces of the latch bumpers 151 and 152 help to bias and push the cantilevered latch tabs against the interlock ledges 131 and 132 as described in further detail below.

The cartridge housing 110 also includes spacing ribs 160-164 along the first side surface 111 and spacing ribs 165-169 along the second side surface 113. The spacing ribs 160-164 are formed as raised and rounded ribs. The spacing ribs 160-164 extend away from the first side surface 111 in a direction perpendicular to the axis “L” of the cartridge housing 110. The spacing ribs 165-169 are formed as raised and rounded ribs that extend away from the second side surface 113 in a direction perpendicular to the axis “L” of the cartridge housing 110. The spacing ribs 160-169 contact inner side surfaces of the release sleeve 150, when the release sleeve 150 is installed around the cartridge housing 110 and the cartridge cover 140. In other words, the inner side surfaces of the release sleeve 150 slide along the outer, rounded edges of the spacing ribs 160-169.

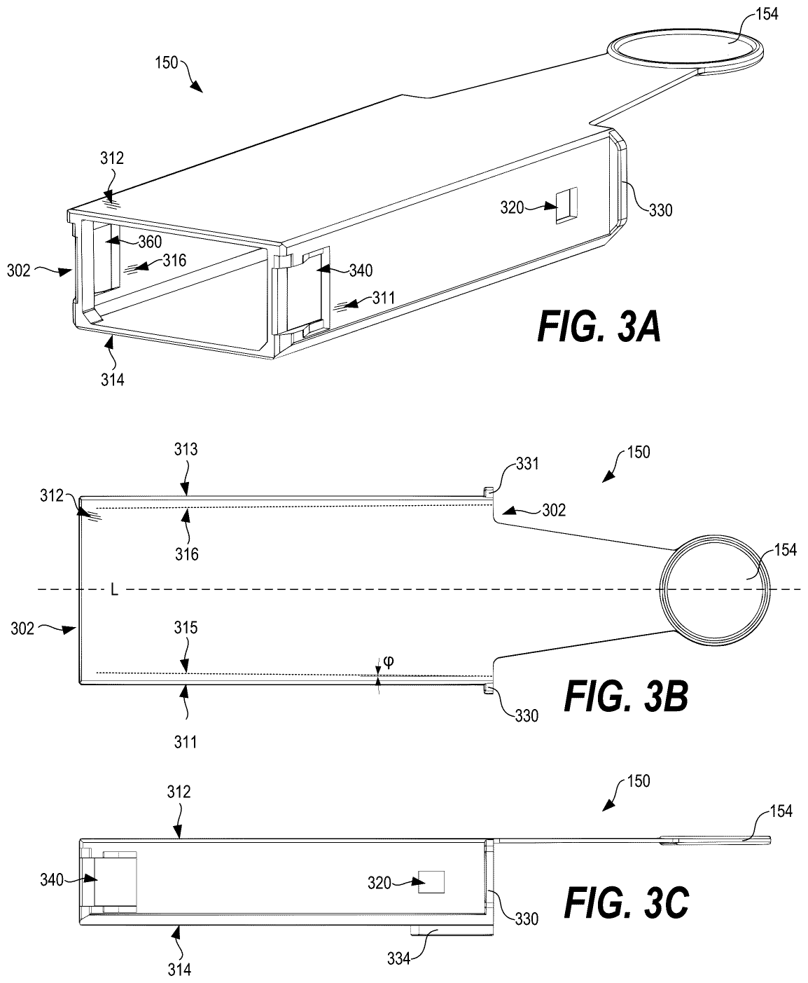

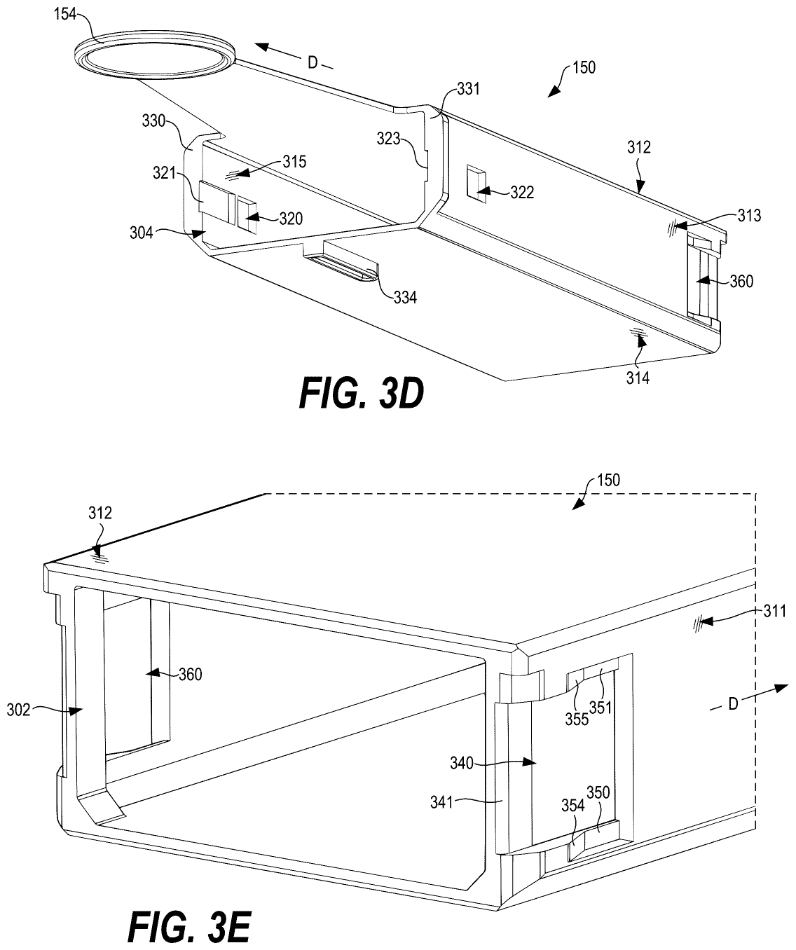

The spacing ribs 164 and 169, which are the closest to the neck 105 of the cartridge housing 110, include interlock teeth 188 and 189 (see FIG. 2C), respectively. The interlock teeth 188 and 189 extend and snap into channel openings of the release sleeve 150 as described below with reference to FIG. 3D. Along each side of the cartridge housing 110, the interlock ledges 131 and 132 are positioned toward the front of the cartridge housing 110, the spacing ribs 164 and 169 with the interlock teeth 188 and 189 are positioned towards the rear of the cartridge housing 110, and the latch bumpers 151 and 152 are positioned between the interlock ledges 131 and 132 and the spacing ribs 164 and 169.

The cartridge housing 110 also includes latching channels 172 and 174 along the first side surface 111 and latching channels 173 and 175 along the second side surface 113. On the first side of the cartridge housing 110, the latching channel 172 is positioned between the spacing ribs 160 and 161 and the latching channel 174 is positioned between the spacing ribs 163 and 164. On the second side of the cartridge housing 110, the latching channel 173 is positioned between the spacing ribs 165 and 166 and the latching channel 175 is positioned between the spacing ribs 168 and 169.

A locking tooth is positioned within each of the latching channels 172-175. As shown among FIGS. 2A-2C, locking teeth 182-185 are positioned within the latching channels 172-175, respectively. As shown in FIG. 2A, the cartridge cover 140 includes latching tabs 142-145. When the cartridge cover 140 is secured over the cartridge housing 110, the latching tabs 142-145 of the cartridge cover 140 fit into the latching channels 172-175 of the cartridge housing 110. Central openings in the latching tabs 142-145 also snap over the locking teeth 182-185 within the latching channels 172-175, securing the latching tabs 142-145 and the cartridge cover 140 in place.

FIG. 3A illustrates a perspective view of the release sleeve 150 of the cartridge 100 shown in FIG. 1A. FIG. 3B illustrates a top-down view of the release sleeve 150 shown in FIG. 3A, and FIG. 3C illustrates a side view of the release sleeve 150 shown in FIG. 3A. Additionally, FIG. 3D illustrates a back perspective view of the release sleeve 150 shown in FIG. 3A. The release sleeve 150 is illustrated as a representative example in FIGS. 3A-3C and is not drawn to any particular scale or size. The orientation, shape, size, style, proportion, and other characteristics of the release sleeve 150 can vary as compared to that shown and among the embodiments.

The release sleeve 150 can be formed from a plastic or polymer, such as LCP, PE, PTFE, fluoropolymer, or other plastic or insulating material(s). The release sleeve 150 is not limited to being formed from polymers, however, and the release sleeve 150 can also be formed from other suitable materials. The release sleeve 150 can be formed using any suitable additive or subtractive manufacturing techniques, including molding, injection molding, printing, and other techniques.

The release sleeve 150 includes a front opening 302 as shown in FIG. 3A and a rear opening 304 as shown in FIG. 3D. The release sleeve 150 is designed to be installed around or over the cartridge housing 110 and the cartridge cover 140. When the release sleeve 150 is installed over the cartridge housing 110 and the cartridge cover 140, the cartridge housing 110 extends through the front opening 302 and the rear opening 304 of the release sleeve 150. FIG. 1A illustrates the release sleeve 150 installed around the cartridge housing 110 and the cartridge cover 140. As described in further detail below, the release sleeve 150 can also slide or move to some extent along the longitudinal axis “L” of the cartridge housing 110 when installed over the cartridge housing 110.

The release sleeve 150 includes side walls, a top wall, and a bottom wall. More particularly, as shown in FIGS. 3A-3D, the release sleeve 150 includes a first side surface 311 of a first side wall, a top side surface 312 of a top side wall, a second side surface 313 of a second side wall, and a bottom side surface 314 of a bottom wall. The first side surface 311 extends in a plane that is separated from and substantially parallel to the second side surface 313 in the example shown. The top side surface 312 extends in a plane that is separated from and substantially parallel to the bottom side surface 314 in the example shown.

The release sleeve 150 also includes a first inner side surface 315 and a second inner side surface 316 within the release sleeve 150. On the exterior of the release sleeve 150, the first side surface 311 extends in a plane that is substantially parallel to the second side surface 313. However, within the release sleeve 150, the first inner side surface 315 does not extend in a plane that is parallel to the second inner side surface 316. Instead, the inner side surfaces 315 and 316 are drafted to expand apart from each other along the longitudinal axis “L” of the release sleeve 150 from the front opening 302 to the rear opening 304 of the release sleeve 150. That is, the inner side surfaces 315 and 316 are closer to each other at the front opening 302 and further apart from each other at the rear opening 304. With respect to the exterior side surface 311, the inner side surface 315 can be formed at an angle φ of between 0.5-5 degrees (°). Examples of φ include 0.5°, 1°, 1.5°, 2°, 2.5°, and 3°, although other angles can be relied upon. Similarly, with respect to the exterior side surface 313, the inner side surface 315 can be formed at an angle of between 0.5-5°.

The inner side surfaces 315 and 316 of the release sleeve 150 can contact the spacing ribs along the side surfaces of the cartridge housing 110 (see FIG. 2C) when the release sleeve 150 is installed over the cartridge housing 110. More particularly, the spacing ribs 160-164 along the first side surface 111 of the cartridge housing 110 can contact the inner side surface 315 of the release sleeve 150 when the release sleeve 150 is installed over the cartridge housing 110. Additionally, the spacing ribs 165-169 along the second side surface 113 of the cartridge housing 110 can contact the inner side surface 316 of the release sleeve 150 when the release sleeve 150 is installed over the cartridge housing 110.

The release sleeve 150 can slide or move to some extent with respect to the cartridge housing 110, as described below. The inner side surfaces 315 and 316 of the release sleeve 150 can contact the outer edges of the spacing ribs 160-169 of the cartridge housing 110 while sliding to some extent. To maintain a minimal clearance or contact between the outer edges of the spacing ribs 160-169 and the angled inner side surfaces 315 and 316 of the release sleeve 150, the spacing ribs 160-169 can be formed to have different lengths. For example, the spacing ribs 160 and 165 can be relatively shorter than the spacing ribs 161 and 166. The spacing ribs 161 and 166 can be relatively shorter than the spacing ribs 162 and 167. The spacing ribs 162 and 167 can be relatively shorter than the spacing ribs 163 and 168, and the spacing ribs 163 and 168 can be relatively shorter than the spacing ribs 164 and 169. Thus, from a front to a rear of the cartridge housing 110, the spacing ribs 160-169 are progressively longer.

The release sleeve 150 includes a first ramped interlock aperture 340 formed through the first side surface 311 and first side wall. The release sleeve 150 also includes a second ramped interlock aperture 360 formed through the second side surface 313 and second side wall. The ramped interlock apertures 340 and 360 are positioned adjacent to the front opening 302 of the release sleeve 150, on the two sides of the front opening 302. The ramped interlock apertures 340 and 360 include openings or apertures through the side walls of the release sleeve 150. Additional features of the ramped interlock apertures 340 and 360 are described below with reference to FIG. 3E.

The release sleeve 150 also includes channel openings 320 and 322. The channel openings 320 and 322 extend through the sidewalls of the release sleeve 150 and are positioned toward a rear of the release sleeve 150, as shown in FIGS. 3A and 3D. Channel slots 321 and 323 are formed in the inner sidewalls of the release sleeve 150. The channel slot 321 leads to and is aligned with the channel opening 320, and the channel slot 323 leads to and is aligned with the channel opening 322.

As shown in FIG. 2C, the spacing ribs 164 and 169 of the cartridge housing 110 include interlock teeth 188 and 189. The interlock teeth 188 and 189 can be snapped into the channel openings 320 and 322 of the release sleeve 150, respectively, when the release sleeve 150 is installed over the cartridge housing 110. To install the release sleeve 150 over the cartridge housing 110, the front of the cartridge housing 110 can be inserted into the rear opening 304 of the release sleeve 150. As the release sleeve 150 is pulled down from the front to the rear of the cartridge housing 110, the interlock teeth 188 and 189 will ultimately extend into the channel slots 321 and 323 and snap into the channel openings 320 and 322. Both the interlock teeth 188 and 189 and the ends of the channel slots 321 and 323 can include angled or chamfered edges to facilitate the interlock teeth 188 and 189 snapping from the channel slots 321 and 323 into the channel openings 320 and 322. The release sleeve 150 can slide or move with respect to the cartridge housing 110 at least to the extent that the interlock teeth 188 and 189 can move within the channel openings 320 and 322, respectively.

Referring to FIG. 3D, the pull tab 154 of the release sleeve 150 extends from the top wall of the release sleeve 150. A force applied to the pull tab 154 in the direction “D” will release or disengage the interlock between the cartridge 100 and the receptacle 200 as described herein. The release sleeve 150 also includes the flange tabs 330 and 331, which extend from the side walls of the release sleeve 150 at the rear of the release sleeve 150. The flange tabs 330 and 331 extend out and beyond the first side surface 311 and the second side surface 313 of the release sleeve 150, respectively, perpendicular to the direction of the longitudinal axis “L”. The flange tabs 330 and 331 provide a secondary means by which force can be applied to the release sleeve 150 in the direction “D”. The release sleeve 150 also includes an orientation key 334, which is formed on the bottom surface 314 of the release sleeve 150. The orientation key 334 provides an additional means to prevent the cartridge 100 from being inserted into the receptacle 200 in an incorrect or unintended orientation, preventing damage to the optical ferrules in the cartridge 100 and the receptacle 200.

FIG. 3E illustrates a front view of the release sleeve 150, and the ramped interlock aperture 340 is shown in more detail. The ramped interlock aperture 340 is formed as an opening through the first side surface 311 and side wall of the release sleeve 150. The ramped interlock aperture 360 also formed as an opening through the second side surface 313 (see FIG. 3D) and side wall of the release sleeve 150. The ramped interlock aperture 340 includes a chamfered corner bar 341, a first depressed platform edge region 350, a second depressed platform edge region 351, a first ramped edge region 354, and a second ramped edge region 355. The first ramped edge region 354 is formed as an angled surface extending from the first depressed platform edge region 350 to the first side surface 311. The second ramped edge region 355 is formed as an angled surface extending from the second depressed platform edge region 351 to the first side surface 311. The ramped interlock aperture 360 also includes a chamfered corner bar, first and second depressed platform edge regions, and first and second ramped edge regions, similar to the ramped interlock aperture 340.

When the release sleeve 150 is installed around the cartridge housing 110, the interlock ledge 131 and the latch bumper 151 (or at least portions thereof) are located within the open window of the ramped interlock aperture 340. Similarly, the interlock ledge 132 and the latch bumper 152 are located within the open window of the ramped interlock aperture 360. As described in further detail below, the cantilevered latch tabs within the receptacle cavity 202 interlock with (i.e., mechanically interfere with) surfaces of the interlock ledges 131 and 132 through the interlock apertures 340 and 360 when the cartridge 100 is fully inserted into the receptacle 200. As also described below, the ramped edge regions of the interlock apertures 340 and 360 can release or disengage the cantilevered latch tabs from the interlock ledges 131 and 132, releasing the cartridge 100 from within the receptacle 200, when the release sleeve 150 is pulled in the direction “D” shown in FIG. 3E.

FIG. 4A illustrates a top-down view of the receptacle 200 shown in FIG. 1A, and FIG. 4B illustrates a bottom-up view of the receptacle 200. The receptacle 200 is illustrated as a representative example in FIGS. 4A and 4B and is not drawn to any particular scale or size. The orientation, shape, size, style, proportion, and other characteristics of the receptacle 200 can vary as compared to that shown and among the embodiments. In some cases, one or more features or components of the receptacle 200 can be omitted. In other cases, the cartridge 100 can include other features or components that are not shown or described.

The receptacle 200 includes a receptacle housing 210 and a receptacle cover 240. The receptacle housing 210 can be formed from a plastic or polymer, such as LCP, PE, PTFE, fluoropolymer, or other plastic or insulating material(s). The receptacle cover 240 can also be formed from a plastic or polymer, such as LCP, PE, PTFE, fluoropolymer, or other plastic or insulating material(s). The receptacle housing 210 and receptacle cover 240 are not limited to being formed from polymers, however and can also be formed from other suitable materials. The receptacle housing 210 and receptacle cover 240 can be formed using any suitable additive or subtractive manufacturing techniques, including molding, injection molding, printing, and other techniques.

As shown, the fiber optic cable ribbons 30 are terminated at the receptacle 200. An array of optical ferrules is positioned and secured within the receptacle 200. Individual fiber optic cables in the cable ribbons 30 are optically terminated to the optical ferrules within the receptacle 200. The receptacle 200 can be installed within the housing of a computing system or environment. For that purpose, the receptacle 200 includes the bulkhead 214 with the fastener eyelet 216 on the top side as shown in FIG. 4A and the bulkhead 215 with the fastener eyelet 217 on the bottom side as shown in FIG. 4B. A top stiffening rail 212 and a bottom stiffening rail 213 are formed in the receptacle housing 210 to provide additional rigidity and support to the bulkheads 214 and 215, respectively.

The receptacle cover 240 is omitted from view in FIG. 4C so that the interior space 201 within the receptacle housing 210 can be seen. When installed over the receptacle housing 210, the receptacle cover 240 encloses the interior space 201 within the receptacle housing 210. The receptacle cover 240 includes latching tabs 242-245, as shown in FIGS. 1A and 4B. The latching tabs 242-245 extend from first and second peripheral side edges of the receptacle cover 240 and interlock with features of the receptacle housing 210, to secure the receptacle cover 240 in place.

The interior space 201 within the receptacle housing 210 is visible in FIG. 4C. The receptacle 200 includes a ferrule sled 410, a spring base 420, and springs 430 and 432 within the interior space 201. The spring base 420 is secured in place at the rear end of the receptacle 200 and provides seats for one end of the springs 430 and 432. The springs 430 and 432 are positioned and compressed between the spring base 420 and the ferrule sled 410. The springs 430 and 432 provide a spring bias that pushes the ferrule sled 410 toward the receptacle cavity 202 at the front end of the receptacle 200.

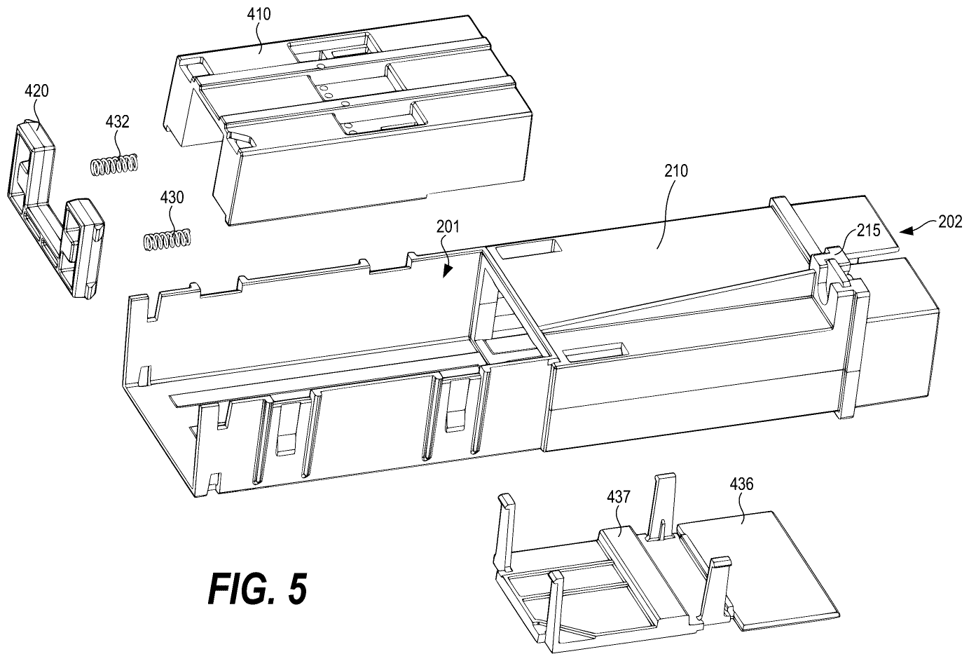

A row of optical ferrules is positioned and secured within the ferrule sled 410. More particularly, although not visible in FIG. 4C, a row of optical ferrules is secured in the ferrule region 412 of the ferrule sled 410. A row of collets is also secured in a collet region 413 within the ferrule sled 410. Fiber optic cables extend from the fiber optic cable ribbons 30, into the interior space 201 of the receptacle housing 210, into the ferrule sled 410, through the collets in the collet region 413, and are optically terminated to the optical ferrules the ferrule region 412. For simplicity, the fiber optic cable ribbons 30 are illustrated as extending only to the ferrule sled 410 in FIG. 4D. The ferrule sled 410, spring base 420, and springs 430 and 432 are described in additional detail below with reference to FIG. 5.

The receptacle housing 210 also includes an orientation keyway 434. The orientation keyway 434 is formed as a type of slot in the bottom wall of the receptacle housing 210 (see also FIG. 1A). The orientation key 334 of the cartridge housing 110, as shown in FIG. 3D, will slide into the orientation keyway 434 of the receptacle housing 210 when the cartridge 100 is correctly oriented and inserted into the receptacle 200. The orientation key 334 and the orientation keyway 434 provide help to prevent the cartridge 100 from being inserted into the receptacle 200 in an incorrect or unintended orientation, preventing damage to the optical ferrules in the cartridge 100 and the receptacle 200.

The receptacle housing 210 also includes cantilevered latch tabs 440 and 460 extending within the receptacle cavity 202. The cantilevered latch tabs 440 and 460 are visible through openings in the receptacle housing 210 in FIGS. 4A-4C. A detail view of the cantilevered latch tab 440 designated “BB” in FIG. 4A is shown in FIG. 4D. FIG. 4E also illustrates a front view of the receptacle housing 210, and the cantilevered latch tabs 440 and 460 are visible within the receptacle cavity 202 of the receptacle housing 210 in FIG. 4E. The cantilevered latch tabs 440 and 460 can be formed from a polymer material integrally with the remainder of the receptacle housing 210 in one example.

Referring between FIGS. 4D and 4E, the cantilevered latch tab 440 includes an extension arm 442, a latch tooth 444 at an end of the extension arm 442, and release knobs 446A and 446B on opposite sides at the end of the extension arm 442. The cantilevered latch tab 440 also includes a curved end 448. Similarly, the cantilevered latch tab 450 includes an extension arm, a latch tooth 464 at an end of the extension arm, and release knobs 466A and 466B on opposite sides at the end of the extension arm. The cantilevered latch tabs 440 and 460 are elastic and can bend to some extent. For example, a force applied in the direction “F” at the end of the cantilevered latch tab 440, as shown in FIG. 4D, can bend the cantilevered latch tab 440 in the direction “F” to some extent. The cantilevered latch tab 440 will return to the position shown in FIG. 4D after the force is removed. The elastic nature of the cantilevered latch tabs 440 and 460 facilitates the interlock feature between the cartridge 100 and the receptacle 200, as described below.

Referring to FIG. 4E, the receptacle housing 210 also includes guide surfaces 480 and 482 along rails in the receptacle cavity 202. The guide surface 480 extends in a plane that is separated from and substantially parallel to the guide surface 482 in the example shown. The guide surfaces 480 and 482 are positioned, and spaced apart, to guide the release sleeve 150 down the receptacle cavity 202. The guide surfaces 480 and 482 help to ensure that the leading chamfered corner bars of the ramped interlock apertures 340 and 360 of the release sleeve 150 push the cantilevered latch tabs 440 and 460 apart upon contact between them.

FIG. 5 illustrates components of the receptacle 200 shown in FIG. 1A according to various embodiments of the present disclosure. The receptacle 200 includes the ferrule sled 410, the spring base 420, and the springs 430 and 432, which all fit within the interior space 201. The spring base 420 is secured in place at the rear end of the receptacle 200 and provides seats for one end of the springs 430 and 432. When the receptacle 200 is assembled, the springs 430 and 432 are positioned and compressed between the spring base 420 and the ferrule sled 410. The springs 430 and 432 provide a spring bias that pushes the ferrule sled 410 toward the receptacle cavity 202 at the front end of the receptacle 200.

A row of optical ferrules is positioned and secured within the ferrule sled 410. A row of collets is also secured within the ferrule sled 410. A sled cover 436 is used to cover and secure the optical ferrules and the collets within the ferrule sled 410. The sled cover 436 includes a raised region 437. A surface of the raised region 437 contacts the collets within the ferrule sled 410, holding the collets in place. Fiber optic cables extend from the fiber optic cable ribbons 30, into the interior space 201 of the receptacle housing 210, into the ferrule sled 410, through the collets, and are optically terminated to the optical ferrules within the ferrule sled 410.

FIG. 6A illustrates the first ramped interlock aperture 340 of the cartridge 100 taken along the sectional plane A-A shown in FIG. 1A. As shown, the ramped interlock aperture 340 is formed as an opening through the first side surface 311 and side wall of the release sleeve 150. The ramped interlock aperture 340 includes the chamfered corner bar 341, the first depressed platform edge region 350, a second depressed platform edge region 351 (see FIG. 3E), a first ramped edge region 354, and a second ramped edge region 355 (see FIG. 3E). The first ramped edge region 354 is formed as an angled surface extending from the first depressed platform edge region 350 to the first side surface 311. When the release sleeve 150 is installed around the cartridge housing 110 as shown in FIG. 6A, the interlock ledge 131 and the latch bumper 151 (or at least portions thereof) are located within the open window of the ramped interlock aperture 340.

FIG. 6B illustrates the cantilevered latch tab 440 of the receptacle 200 interlocked with the ramped interlock aperture 340 of the cartridge 100 taken along the sectional plane A-A shown in FIG. 1A. In FIG. 6B, the cartridge 100 is fully inserted into the receptacle 200 and interlocked with the receptacle 200. As shown, the latch tooth 444 of the cantilevered latch tab 440 is interlocked with the interlock ledge 131 on one side of the cartridge housing 110. Although not shown in FIG. 6B, the latch tooth 464 of the cantilevered latch tab 460 on the other side of the receptacle 200 is also interlocked with the interlock ledge 132 on the other side of the cartridge housing 110. Once interlocked, the cartridge 100 cannot be pulled out from within the receptacle 200 by pulling on the cable assembly 20, for example, under expected ranges of forces and without damage. Thus, the connector assembly 10 includes features that prevent the unintended or inadvertent removal of the cartridge 100 from the receptacle 200, which would result in the disruption of data communications through the connector assembly 10.

FIG. 6C illustrates the cantilevered latch tab and the ramped interlock aperture of the cartridge taken along the sectional plane C-C shown in FIG. 6B according to various embodiments of the present disclosure. The latch tooth 444 of the cantilevered latch tab 440 is interlocked with the interlock ledge 131 on one side of the cartridge housing 110. The release knob 446B is seated and resting against the depressed platform edge region 350, as can be appreciated by a comparison of FIGS. 6A and 6C.

From the interlocked configuration shown in FIG. 6C, the ramped edge regions of the interlock aperture 340 can release or disengage the cantilevered latch tab 440 from the interlock ledge 131. More particularly, when the release sleeve 150 is pulled in the direction “D,” the ramped edge region 354 will wedge under the release knob 446B of the cantilevered latch tab 440. This force, which is also in the direction “F” shown in FIG. 4D, will cause the cantilevered latch tab 440 to bend and move away from the interlock ledge 131, ultimately removing the interference between the latch tooth 444 and the interlock ledge 131. Although not shown in FIG. 6C, the ramped edge region 355 (see FIG. 3E) will also wedge under the release knob 446A of the cantilevered latch tab 440 when the release sleeve 150 is pulled in the direction “D.” At the same time, the cantilevered latch tab 460 can be released from the interlock aperture 360 when the release sleeve 150 is pulled in the direction “D.”

Terms such as “top,” “bottom,” “side,” “front,” “back,” “right,” and “left” are not intended to provide an absolute frame of reference. Rather, the terms are relative and are intended to identify certain features in relation to each other, as the orientation of structures described herein can vary. The terms “comprising,” “including,” “having,” and the like are synonymous, are used in an open-ended fashion, and do not exclude additional elements, features, acts, operations, and so forth. Also, the term “or” is used in its inclusive sense, and not in its exclusive sense, so that when used, for example, to connect a list of elements, the term “or” means one, some, or all of the elements in the list.

Combinatorial language, such as “at least one of X, Y, and Z” or “at least one of X, Y, or Z,” unless indicated otherwise, is used in general to identify one, a combination of any two, or all three (or more if a larger group is identified) thereof, such as X and only X, Y and only Y, and Z and only Z, the combinations of X and Y, X and Z, and Y and Z, and all of X, Y, and Z. Such combinatorial language is not generally intended to, and unless specified does not, identify or require at least one of X, at least one of Y, and at least one of Z to be included. The terms “about” and “substantially,” unless otherwise defined herein to be associated with a particular range, percentage, or related metric of deviation, account at least for some manufacturing tolerances between a theoretical design and a manufactured product or assembly, such as the geometric dimensioning and tolerancing criteria described in the American Society of Mechanical Engineers (ASME®) Y14.5 and the related International Organization for Standardization (ISO®) standards. Such manufacturing tolerances are still contemplated, as one of ordinary skill in the art would appreciate, although “about,” “substantially,” or related terms are not expressly referenced, even in connection with the use of theoretical terms, such as the geometric “perpendicular,” “orthogonal,” “vertex,” “collinear,” “coplanar,” and other terms.

The above-described embodiments of the present disclosure are merely examples of implementations to provide a clear understanding of the principles of the present disclosure. Many variations and modifications can be made to the above-described embodiments without departing substantially from the spirit and principles of the disclosure. In addition, components and features described with respect to one embodiment can be included in another embodiment. All such modifications and variations are intended to be included herein within the scope of this disclosure.

What is claimed is:

1. An optical connector assembly, comprising:
an optical receptacle comprising a receptacle housing, the receptacle housing comprising a receptacle cavity and a cantilevered latch tab within the receptacle cavity, the cantilevered latch tab comprising an extension arm, a latch tooth at an end of the extension arm, and a release knob; and
an optical cartridge comprising:
a cartridge housing comprising a plurality of spacing ribs and an interlock ledge along a side of the cartridge housing; and
a release sleeve extending around a length of the cartridge housing, the release sleeve comprising a ramped interlock aperture.

2. The optical connector assembly according to claim 1, wherein:
the cartridge housing further comprises a latch bumper along the side of the cartridge housing;
a spacing rib among the plurality of spacing ribs comprises an interlock tooth; and
along the side of the cartridge housing, the interlock ledge is positioned toward a front of the cartridge housing, the spacing rib with the interlock tooth is positioned towards a rear of the cartridge housing, and the latch bumper is positioned between the interlock ledge and the spacing rib with the interlock tooth.

3. The optical connector assembly according to claim 1, wherein:
the optical receptacle comprises a first row of optical ferrules; and
the optical cartridge comprises a second row of optical ferrules.

4. The optical connector assembly according to claim 1, wherein the ramped interlock aperture comprises a chamfered corner bar, an aperture through a side wall of the release sleeve, a depressed platform edge region along an edge of the aperture, and a ramped edge region along the edge of the aperture.

5. The optical connector assembly according to claim 4, wherein the interlock ledge of the cartridge housing is exposed through the aperture of the ramped interlock aperture.

6. The optical connector assembly according to claim 5, wherein, when the optical cartridge is inserted into the receptacle cavity of the optical receptacle, the latch tooth of the cantilevered latch tab mechanically interferes with the interlock ledge of the cartridge housing, to lock the optical cartridge within the optical receptacle.

7. The optical connector assembly according to claim 5, wherein, when the optical cartridge is locked within the optical receptacle, the release knob of the cantilevered latch tab is seated on the depressed platform edge region of the ramped interlock aperture.

8. The optical connector assembly according to claim 1, wherein the release sleeve further comprises a pull tab extending from a top wall of the release sleeve and an orientation key formed on a bottom wall of the release sleeve.

9. The optical connector assembly according to claim 1, wherein the release sleeve further comprises flange tabs extending from side walls of the release sleeve.

10. The optical connector assembly according to claim 1, wherein the optical receptacle further comprises a ferrule sled and a spring to provide a spring bias to the ferrule sled.

11. The optical connector assembly according to claim 1, wherein inner side surfaces of the release sleeve slide along edges of the spacing ribs of the cartridge housing.

12. The optical connector assembly according to claim 11, wherein:
from a front to a rear of the release sleeve, the inner side surfaces are drafted to expand apart from each other; and
from a front to a rear of the cartridge housing, the spacing ribs of the cartridge housing are progressively longer.

13. An optical cartridge, comprising:
a cartridge housing comprising a plurality of spacing ribs and an interlock ledge along a side of the cartridge housing; and
a release sleeve extending around a length of the cartridge housing, the release sleeve comprising a ramped interlock aperture.

14. The optical cartridge according to claim 13, wherein the ramped interlock aperture comprises a chamfered corner bar, an aperture through a side wall of the release sleeve, a depressed platform edge region along an edge of the aperture, and a ramped edge region along the edge of the aperture.

15. The optical cartridge according to claim 14, wherein the interlock ledge of the cartridge housing is exposed through the aperture of the ramped interlock aperture.

16. The optical cartridge according to claim 13, wherein the release sleeve further comprises a pull tab extending from a top wall of the release sleeve and an orientation key formed on a bottom wall of the release sleeve.

17. The optical cartridge according to claim 13, wherein the release sleeve further comprises flange tabs extending from side walls of the release sleeve.

18. An optical receptacle, comprising:
a receptacle housing, the receptacle housing comprising a receptacle cavity and a cantilevered latch tab within the receptacle cavity, the cantilevered latch tab comprising an extension arm, a latch tooth at an end of the extension arm, and a release knob;
a ferrule sled; and
a spring to provide a spring bias to the ferrule sled.

19. The optical receptacle according to claim 18, wherein the receptacle housing further comprises an orientation keyway formed as a slot in a bottom wall of the receptacle housing.

20. The optical receptacle according to claim 18, wherein the receptacle housing further comprises guide surfaces on rails within the receptacle cavity.
